(19) United States
(12) Patent Application Publication
(10) Pub. No.: US 2011/0109576 A1
(43) Pub. Date: May 12, 2011

(54) METHOD OF ADAPTING DISPLAY PARAMETERS OF A DISPLAY DEVICE, IN PARTICULAR AN ON-BOARD DISPLAY DEVICE IN AN AIRCRAFT

(75) Inventor: Brice GIANNELLI, L'isle Jourdain (FR)

(73) Assignee: Airbus Operations (S.A.S.), Toulouse Cedex (FR)

(21) Appl. No.: 12/912,064

(22) Filed: Oct. 26, 2010

(30) Foreign Application Priority Data
Nov. 10, 2009 (FR) 09 57932

(51) Int. Cl. G08B 21/00; G06F 3/041

(52) U.S. Cl. 345/173; 340/945

(57) ABSTRACT

A method for adapting display parameters of a display device (10) on board a vehicle, the display parameters having default values in a rated operating context of the said vehicle, comprises the following steps:
detecting a disturbed operating context of the said vehicle; and
automatically modifying a value of at least one display parameter of the said display device (10).

This invention relates to a method for adapting display parameters of a display device on board a vehicle.

It also relates to a display device on board a vehicle, using the adaptation method, as well as to an aircraft comprising such a display device in the cockpit.

In general, this invention relates to the use of on-board display devices and to their adaptability to different operating conditions of the vehicle.

In particular, when the display device is integrated into a cockpit of an aircraft, the latter regularly is subject to areas of turbulence on its path, creating vibrations in the aircraft as a whole making readability and use of the display device difficult.

In fact, a display device is parameterized by default so that the display parameters used for display of information items on a screen are well adapted to a rated operating context of the vehicle, without any disturbances.

Generally, this parameterization of the display device by default results from a compromise between the quantity of information items to be displayed and their readability.

This invention has as an object to improve and facilitate the use of a display device on board a vehicle, in particular when the vehicle is subject to disturbances in its operation.

To this end, according to a first aspect, this invention relates to a method for adapting display parameters of a display device on board a vehicle, the display parameters having default values in a rated operating context of the vehicle.

According to the invention, the adaptation method comprises the following steps:
detecting a disturbed operating context of the vehicle; and
automatically modifying a value of at least one display parameter of the display device.

In this way, the same display device may offer at least two display modes, a first display mode in which the display parameters have default values corresponding to operation in a rated context of the vehicle and a second display mode in which the display parameters have values modified for adapting to a disturbed operating context of the vehicle.

By virtue of the automatic modification of the display parameter values, the readability of the display device may be improved automatically during a disturbed operating context of the vehicle, which generally also corresponds to a difficult operational phase for piloting the vehicle.

In practice, the display parameters comprise the size of alphanumeric characters and/or graphical objects displayed on the display device, a display color or colors and the positioning of alphanumeric characters and/or graphical objects on the display device.

Thus, by modifying the size of the characters or the graphical objects displayed, or even the positioning of these graphical objects or characters on the display device and the contrast of the colors, it is possible to adapt the readability of the displayed information items to the operating conditions of the vehicle.

Furthermore, a graphical object and/or alphanumeric characters displayed in the rated context are eliminated from a display area of the display device during the modification step.

The second display mode, used in a disturbed context, results from a compromise between the quantity of information items displayed and their readability, different from the one adopted for the first display mode. Thus, in this second display mode, the readability can be enhanced to the detriment of the quantity of displayed information items.

According to a practical embodiment, in the modification step, the size of a graphical object and/or of alphanumeric characters is increased in order to increase the readability of the displayed information items intended for the user of the vehicle. In a disturbed context, generating random amplitude and frequency vibrations, the enlarging of objects, or of texts displayed facilitates reading thereof.

In particular, when the graphical object identifies a touch-control area, the size of the touch-control area is increased during the modification step.

In this way, activation of this touch control by the user directly at the screen of the display device is facilitated during an operation of the vehicle in disturbed context.

By expanding the size of the touch-control area, its activation by the user, in particular by means of a finger or stylet acting on the screen of the display device is facilitated.

The adaptation method advantageously further comprises a step of modifying a rule for detecting a force on the touch-control area, a force-detection threshold value being increased.

In this way it is possible to prevent an untimely pressing on a touch-control area, linked in particular to difficulties encountered by the user in correctly positioning a finger or a stylet on a touch-control area of the screen during operation of the vehicle in a disturbed context, from setting off an undesired control.

According to a second aspect, this invention also relates to a display device on board a vehicle, associated with display parameters having default values in a rated operating context of the vehicle.

This display device on board a vehicle comprises:
means for detection of a disturbed operating context of the vehicle; and
means for automatic modification of a value of at least one display parameter of the display device.

This display device offers characteristics and advantages similar to those described above in connection with the method for adaptation of display parameters used in the display device.

According to a specific embodiment of the invention, the display device further comprises a manual control means adapted for controlling the modification of a value of at least one display parameter of the display device.

In this way it is possible for the user of the vehicle to modify the display mode of the information items by a manual action, when the user encounters a difficulty in using the display device parameterized by default. By virtue of the manual control, he also may go back to the default display mode, if he so desires.

Finally, according to a third aspect, this invention relates to an aircraft comprising a cockpit, the latter comprising at least one display device according to the invention.

This aircraft offers characteristics and advantages similar to those described above.

In particular, in an aircraft, the means for detection of a disturbed context are adapted for detecting an area of turbulence in the path of the aircraft.

Other features and advantages of the invention also will become apparent in the description below.

On the attached drawings, presented by way of non-limitative examples:

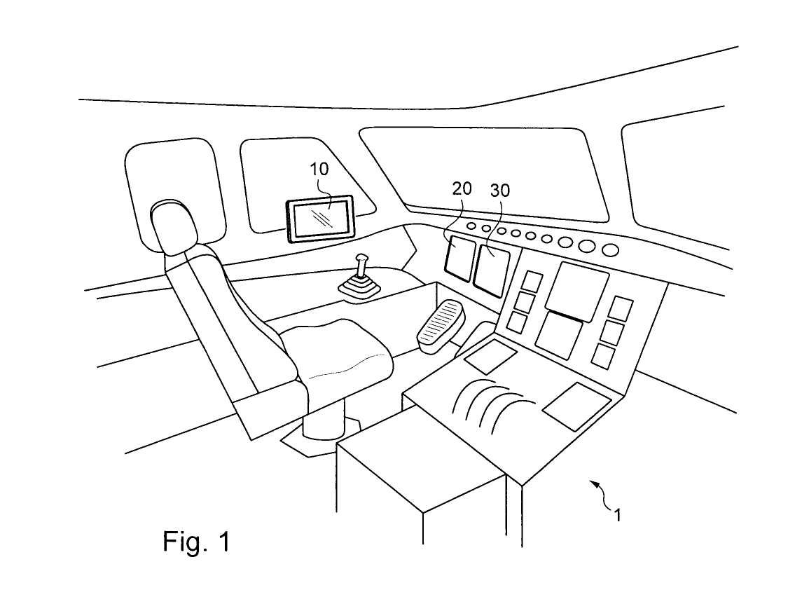

FIG. 1 is a partial schematic view in perspective of a cockpit of an aircraft integrating a display device according to an embodiment of the invention;

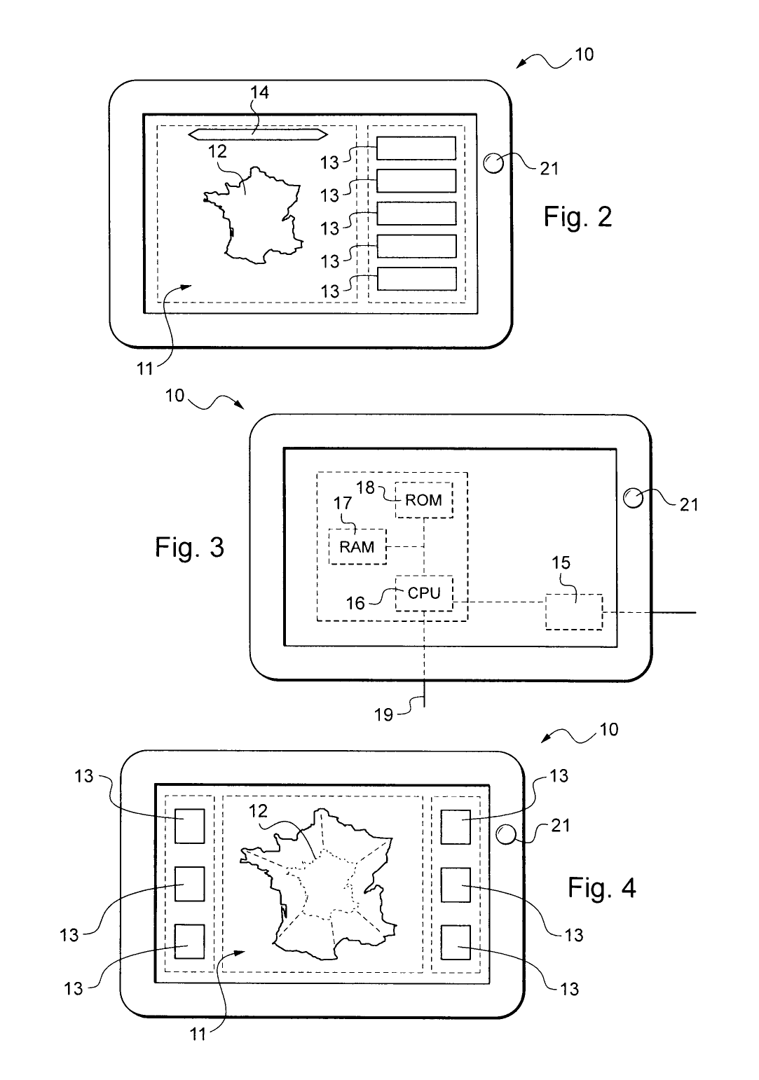

FIG. 2 is a front schematic view of a display device according to an embodiment of the invention, in a display mode in a rated operating context;

FIG. 3 is a front schematic view of the display device of FIG. 2, illustrating the means for using the adaptation method according to this invention; and

FIG. 4 is a front schematic view of display device of FIG. 2, in a display mode in a disturbed operating context.

A cockpit 1 of an aircraft according to an embodiment of the invention has been illustrated on FIG. 1.

An aircraft usually comprises, in a cockpit 1, one or more display devices 10, 20, 30 adapted for displaying on screens the information items needed by the pilot for piloting the aircraft.

In particular, as illustrated on FIG. 1, cockpit 1 comprises a touch-screen type display device 10 disposed on an opening panel of cockpit 1.

It also comprises different display devices 20, 30 disposed facing the pilot.

The left side of cockpit 1 of the aircraft has been illustrated on FIG. 1.

Of course, a similar arrangement may be provided on the right side of cockpit 1, facing the second piloting seat.

In an aircraft, the display devices are adapted in particular for displaying different maps or charts needed for following the path of the aircraft.

In particular, the display system may comprise at least one CDS (acronym for the English term “Control and Display System”) screen, making it possible to display the electronic flight instruments.

It further may comprise an EFB (acronym for the English term “Electronic Flight Bag”) screen making it possible to interface a documentation and flight information item data-processing system.

A display device 10 according to the invention, on board in cockpit 1 of the aircraft, has been illustrated on FIG. 2 by way of non-limitative example.

In the embodiment illustrated on FIG. 2, the screen of display device 10 here is adapted, in a manner by no means limitative, for displaying a graphical object 12 in a display area 11.

It also comprises touch-control areas 13 enabling the pilot to interact directly through a touch control on the screen of display device 10.

A text area 14 also may comprise information items intended for the pilot.

Of course, the displayed information items are not limited to the examples described above.

Digital or textual information items may be displayed with the aid of alphanumeric characters in standard manner in different areas of the screen of the display device.

Furthermore, the positioning of the different elements (areas for control 13, graphical objects 12) on the screen is presented only by way of illustration and may be modified.

On FIG. 2, the display parameters used by the display device have values defined by default for a rated operating context of the aircraft.

In particular, when the aircraft is operating under normal flight conditions, the display device allows an optimal display of the information items that must be available to the pilot, in terms of quantity as well as positioning on the screen.

The display parameters define in particular the size of the alphanumeric characters and/or graphical objects displayed, as well as their positioning on the screen of the display device.

The display parameters also may define display colors for the background of the screen or even for the graphical objects displayed, or for the alphanumeric characters displayed. The display parameters define in particular the color contrasts and the brightness of the screen.

As illustrated on FIG. 3, for the use of a method for adapting display parameters, display device 10 is associated with means for detection 15 of a disturbed operating context of the vehicle carrying the display device on board.

As relates to an aircraft, a disturbed operating context is noted, for example, when the aircraft is passing through an area of turbulence.

In this case, the random frequency and amplitude vibrations hamper the use and readability of the display device provided for operating under rated operating conditions of the aircraft.

In this embodiment, the detection means 15 may be connected to an available system in the aircraft making it possible to detect operation of the aircraft in a disturbed context.

Such a system may consist, for example, of a weather radar coupled with a system for path analysis of the aircraft, adapted for transmitting information items on the presence of turbulence.

Management of the display device and its display parameters is implemented from a microprocessor 16 connected in standard manner to a random access memory 17 and a read-only memory 18 adapted for managing the information items and their display on the screen of the display device.

Management system 16, 17, 18 as a whole may be connected by standard connection means 19 to outside sensors making it possible to obtain information items to be displayed on the screen of display device 10.

In particular, management system 16, 17, 18 is adapted for storing a set of default values of the display parameters, allowing display of information items in a rated operating context of the vehicle.

It also is adapted for storing a set of modified values of the display parameters, that may be used when a disturbed operating context of the aircraft is detected.

In this way management system 16, 17, 18 integrates means for automatic modification of one or more values of display parameters of the display device when detection means 15 detect a disturbed context, and for example passage by the aircraft through an area of turbulence.

The display device also may comprise a means for manual control, illustrated by way of example by an activation button 21 available on the front face of display device 10, enabling the user to control the modification means integrated into management system 16, 17, 18 in order to modify the display mode of display device 10.

In general, management system 16, 17, 18 comprises all the software means needed for implementing the method for adaptation of the display parameters, automatically or at the request of the user.

The display device of FIG. 2 in which values of the display parameters have been modified, has been illustrated on FIG. 4.

In particular, the size of graphical object 12 is increased, so as to facilitate reading by the user.

This increase in the size of a graphical object may be interpreted as a zoom-in on display area 11 of display device 10.

In this exemplary embodiment, text area 14 then is eliminated from display area 11 of display device 10.

The display mode used in the disturbed operating context of the aircraft makes it possible to favor the readability of necessary, or even indispensable, information items on the screen of display device 10, to the detriment of less important information items which then are eliminated from the screen of the display device.

Furthermore, the size of touch-control areas 13 also is increased so as to facilitate their activation by the pilot.

It will be noted, in particular, that during passage through areas of turbulence, the vibrations generated in the cockpit make it difficult for the pilot to activate small-size touch controls on the screen of the display device.

Thus, by increasing the size of these touch-control areas 13, their manipulation by the pilot with the aid of the finger or a stylet is facilitated.

Each touch-control area 13 preferably is associated with a rule for detecting a force on this touch-control area.

In practice, a detection rule uses a threshold value for detecting forces, making it possible to detect a pressure (or force) on the touch-control area.

Operation by capacitive or resistive detection of a touch control is well known to the individual skilled in the art and does not need to be described in detail here.

When a disturbed operating context of the vehicle is detected, management system 16, 17, 18 of the display device is further adapted for modifying this detection rule associated with each touch-control area.

In practice, the force detection threshold value of this detection rule is increased so as to prevent untimely pressures on a touch-control area from setting off an action not desired by the pilot.

This invention thus makes it possible both to retain display parameters well adapted to the rated operation of the aircraft and to offer a second display mode in which the modified values of the display parameters are adapted for improving readability and accessibility of the information items displayed on the screen of display device 10.

In a second display mode, the size and/or the positioning of the displayed information items thus may be modified, if need be to the detriment of non-indispensable or less useful information-item elements, which then are eliminated from display area 11 of display device 10.

When detection means 15 no longer detect a disturbed operating context of the vehicle, the display parameters are automatically reinitialized with the default values provided for operation of the vehicle in a rated context.

Furthermore, at any moment the user may command reinitialization with the default values of the display parameters by virtue of the manual control means.

Of course, this invention is not limited to the exemplary embodiment described above.

In this way, the display device in particular may be on board different types of vehicles, and particularly an automobile or a ship, in which operating conditions also may disturb the readability and use of the display device.

Furthermore, the disturbed context is not limited to turbulence generating vibrations in the vehicle, but also may correspond to specific events, external or internal to the vehicle, modifying the operating conditions.

1. Method for adapting display parameters of a display device (10) on board a vehicle, the display parameters having default values in a rated operating context of the said vehicle, characterized in that it comprises the following steps:
detecting a disturbed operating context of the said vehicle; and
automatically modifying a value of at least one display parameter of the said display device (10).

2. Adaptation method according to claim 1, characterized in that the said display parameters comprise the size of alphanumeric characters and/or graphical objects (12) displayed on the said display device (10), a display color or colors and the positioning of alphanumeric characters and/or graphical objects on the said display device (10).

3. Adaptation method according to one of claims 1 or 2, characterized in that in the said step of modifying, the size of a graphical object (12) and/or of alphanumeric characters is increased.

4. Adaptation method according to one of claims 1 to 3, characterized in that a graphical object and/or alphanumeric characters displayed in the said nominal context are eliminated from a display area (11) of the display device (10) during the modification step.

5. Adaptation method according to one of claims 1 to 4, the said display device (10) being adapted for displaying at least one touch-control area (13) and using a rule for detecting a force on the said at least one touch-control area (13) from a force detection threshold value, characterized in that it further comprises a step of modifying the said detection rule, the force detection threshold value on the said at least one touch-control area (13) being increased.

6. Display device on board a vehicle, associated with display parameters having default values in a rated operating context of the said vehicle, characterized in that it comprises:
means for detection (15) of a disturbed operating context of the said vehicle; and
means for automatic modification (16, 17, 18) of a value of at least one display parameter of the said display device (10).

7. Display device according to claim 6, characterized in that it further comprises a manual-control means (21) adapted for controlling the modification of a value of at least one display parameter of the said display device (10).

8. Display device according to one of claims 6 or 7, characterized in that it comprises means (15, 16, 17, 18) adapted for implementing the adapted method according to claims 1 to 5.

9. Aircraft comprising a cockpit (1), characterized in that the said cockpit (1) comprises at least one display device (10, 20, 30) according to claims 6 to 8.

10. Aircraft according to claim 9, characterized in that means for detection (15) of a disturbed context are adapted for detecting an area of turbulence in the path of the aircraft.
